(19) United States
(12) Patent Application Publication
(10) Pub. No.: US 2019/0130310 A1
(43) Pub. Date: May 2, 2019

(54) COGNITIVE IT EVENT HANDLER

(71) Applicant: International Business Machines Corporation, Armonk, NY (US)

(72) Inventors: Praveen Kumar Madhava Rao, Brno-Kralovo Pole (CZ); Ashwini Alaguvel, Chennai (IN); Anuradha Rao, Poughkeepsie, NY (US)

(21) Appl. No.: 15/800,203

(22) Filed: Nov. 1, 2017

(51) Int. Cl. G06N 99/00; G06N 5/02; G06F 17/30

(52) U.S. Cl. CPC G06N 99/005; G06F 17/30401; G06F 17/30424; G06N 5/022

(57) ABSTRACT

A system, method and program product for managing IT events using a cognitive handler. A method is disclosed that includes: receiving an event in the form of a human readable message; using a discovery service that includes a machine learning model to process the event relative to a knowledgebase of previously captured events; identifying a set of matching events and associated solutions; in response to identifying a matching event that has a solution confidence greater than a predetermined threshold, automatically applying the solution to obtain a resolution; and updating the machine learning model based on the resolution.

### TECHNICAL FIELD

The subject matter of this invention relates to managing events in an information technology (IT) infrastructure, and more particularly to a cognitive event handler that employs dynamic machine learning to analyze and handle events from different elements of an IT infrastructure.

### BACKGROUND

Handling of alerts, incidents and errors (i.e., events) generated within an information technology (IT) infrastructure such as a data center, network center, etc., remains a major challenge for administrators overseeing such systems. For example, administrators must not only be available to interpret such events, but must also resolve issues, communicate statuses to stakeholders, and document results. For stakeholders, the process can be equally frustrating as they must deal with situations wherein the administrator is unavailable, is slow in providing a status, is having difficulty determining what is causing the event, etc.

Furthermore, in some cases, reported events may be invalid or duplicates, which further complicates the process. Additionally, typical environments may have numerous data processing systems, which can greatly complicate the process of assessing events. Even in cases where reported events have known solutions, the administrator may or may not be aware of such solutions. Unfortunately, current approaches do not provide a comprehensive solution to handling of these challenges.

### SUMMARY

Aspects of the disclosure provide a cognitive event handling system and method for event generated from within an IT infrastructure. The approach employs “dynamic” machine learning self-reflections involving multiple aspects the IT infrastructure including applications, operating system health, network health, load balancing, etc. Features include error relation and dependency match in which captured events are analyzed and associated with a particular IT resource, and resources and alerting threshold are automatically reconfigured.

A first aspect discloses method of handling events gathered from an information technology (IT) infrastructure, including: receiving an event in the form of a human readable message; using a discovery service that includes a machine learning model to process the event relative to a knowledgebase of previously captured events; identifying a set of matching events and associated solutions; in response to identifying a matching event that has a solution confidence greater than a predetermined threshold, automatically applying the solution to obtain a resolution; and updating the machine learning model based on the resolution.

A second aspect discloses a computing system having a cognitive agent for handling events gathered from an information technology (IT) infrastructure, including: an event analyzer module for receiving an event; a solution availability module that interfaces with a machine learning system to process the event relative to a knowledgebase of previously captured events and to identify a set of matching events and associated solutions; an automated solution module that automatically applies the solution to obtain a resolution in response to identifying a matching event that has a solution confidence greater than a predetermined threshold; an administrative solution module that notifies an administrator of the event when there are no matching events or there are no matching events having a solution confidence greater than the predetermined threshold; and a feedback module for updating a machine learning model based on the resolution.

A third aspect discloses a computer program product stored on a computer readable storage medium, which when executed by a computing system, provides handling events gathered from an information technology (IT) infrastructure, the program product comprising: program code for receiving an event in the form of a human readable message; program code for interfacing with a machine learning system to process the event relative to a knowledgebase of previously captured events; program code for capturing a set of matching events and associated solutions from the machine learning system; program code for automatically applying the solution to obtain a resolution in response to identifying a matching event that has a solution confidence greater than a predetermined threshold; and program code for providing event resolution information to the machine learning system to update an associated machine learning model.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a cognitive agent for handling IT events according to embodiments.

FIG. 2 shows a flow diagram of a process for handling events when an automated solution is not available according to embodiments.

FIG. 3 shows a flow diagram of a process for handling events when one or more solutions are identified from a knowledge database according to embodiments.

FIG. 4 shows knowledge database event records according to embodiments.

FIG. 5 shows knowledge database event records according to embodiments.

FIG. 6 shows a layout for implementing an event scanner according to embodiments.

FIG. 7 shows a computing system having a cognitive agent according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

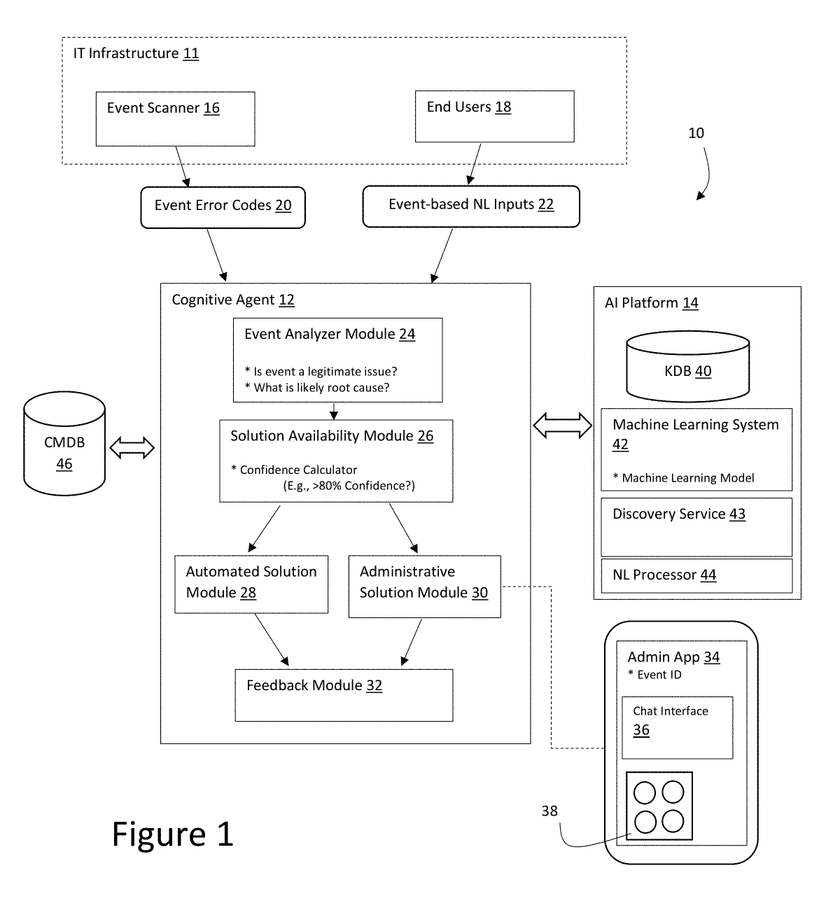

Referring now to the drawings, FIG. 1 depicts a cognitive event handler architecture 10 for handling events within an information technology (IT) infrastructure 11. For the purposes of this disclosure, the term “IT infrastructure” generally refers to an enterprise's entire collection of hardware, software, networks, data centers, facilities and related equipment used to develop, test, operate, monitor, manage and/or support information technology services. An “event” generally refers to any alert, reported problem, potential issue, incident, error, notification, etc., that occurs within the IT infrastructure. A “resolution” refers to information associated with an event and any applied solution, whether successful or not.

Central to cognitive event handler architecture 10 is a cognitive agent 12 that receives events and leverages an artificial intelligence platform 14 to cognitively learn about and resolve events with or without the help of a systems administrator (“administrator”). AI platform 14 may for example comprise a system such as IBM® Watson™ and generally includes a machine learning system 21. Machine learning system 42 includes a machine learning model (e.g., a neural network, etc.) that can be trained and updated with event resolution information, which is stored in knowledgebase (KDB) 40. Based on inputted human readable event information (e.g., natural language, error codes, etc.), machine learning system 42 is adapted to output a ranked list of matching events from KDB 40. In one illustrative embodiment, a discovery service 43, such as that provided by Watson™ may be utilized. Discovery service 43 is adapted to quickly locate the best information within large amounts of unstructured content using a “passage retrieval” capability. Passage retrieval first finds pieces of information within large and varied documents that are ingested into the discover service 43. After documents are found, passage retrieval identifies the most likely, relevant snippets based on the inputted query, and uses intelligent scoring algorithms to rank the passages.

Discovery service 43 may for example utilize a learn to rank (LTR) algorithm, which solves ranking problems for lists of items. The aim of LTR is to come up with optimal ordering of those items. As such, unlike traditional approaches, LTR does not care much about the exact score that each item gets, but cares more about the relative ordering among all the items.

In the embodiment shown, events may be collected either from an event scanner 16 that submits event-based error codes 20 or from end users 18 that submit an event-based natural language (NL) inputs 22. An NL processor 44 may be utilized to interpret event information and other NL inputs. Although shown as part of AI platform, NL processing may also be done by cognitive agent 12. Once an event is collected, error information and like is parsed and analyzed by event analyzer module 24 and discovery service 43 to determine a root cause of the problem, e.g., network failure, application failure, hardware device failure, etc.

Event scanner 16 may for example comprise a system that collects alerts from the various IT components in IT infrastructure 11. For example, event scanner 16 may include agents or filters installed in or capable of monitoring all aspects of the infrastructure 11, including, e.g., firewall components, operating systems, network devices, storage devices, servers, user applications, etc. Generally, a reported event occurs in the form of an error code and associated component or set of components.

Event-based NL inputs 22 generally include events (e.g., reports or problems) end users 18 enter electronically via email or text, or via voice using natural language (NL). NL inputs 22 generally comprise unstructured information, e.g., “Hi, this is John Smith, I am unable to log into the system.” Although not shown, the end users 18 may also be able to enter structured information, e.g., using online forms, drop down boxes, robotic chat systems, etc. In other cases, an administrator, e.g., at a help desk, may enter events (either structured or unstructured) that were received by end users.

Regardless, once an event is generated, the event is captured by event analyzer module 24, which first determines if the event is a legitimate issue. For example, if the event is a duplicate of a previously reported event or if the event is known not to be an actual issue, the event can be ignored. Accordingly, in the case where an error code 20 is received, a lookup may be performed into a knowledge database (KDB) 40 to see if the error code has previously occurred. In the case where an NL input 22 is received, NL processor 44 may be used to determine the context of the event and perform a look up in the KDB 40. Based on the results of the look-up, a decision can be made regarding whether the event is a legitimate issue either automatically or by an administrator.

In the case where the event is deemed legitimate, the event is logged into a configuration management database (CMDB) 46 with an ID, description, etc., which tracks all open issues. Discovery service 43 may be employed by event analyzer module 24 to determine a likely root cause of the problem. For example, a particular error code involving a malfunctioning application may suggest that the problem relates to a bug in the application. However, discovery service 43, which can be employed to comb through previous events, documents, postings, etc., might determine that the likely cause is memory issue on a server.

Next, a solution availability module 26 ascertains whether a known solution exists for the issue. Solution availability may be obtained via machine learning system 42, which for example uses discovery service 43 to identify related events in the KDB 40. Solution availability module 26 may utilize a confidence calculator to evaluate and/or assign a confidence score of a returned solution.

If the confidence score is above a threshold (e.g., 80%), then the event is handled by an automated solution module 28. Automated solution module 28 automatically applies the solution with little or no assistance from an administrator. For example, automated solution module 28 may send a text to the end user 18 that provides a work-around to the problem, or automatically implement a series of steps (e.g., update the driver and reboot the device). When a valid solution to the problem is obtained and confirmed by the end user 18 or other stakeholder, the automated solution module 28 can close the event in the CMDB 46, thus indicating a resolution.

If the confidence score of a matching event/solution is below the threshold, there is no known solution, or the automated solution fails, then the event is handled by an administrative solution module 30. Administrative solution module 30 causes an alert or notice to be sent to an administrator, e.g., via an admin app 34 on a mobile device, who is responsible for obtaining a resolution of the event. From the admin app 34, the administrator can, e.g., open a chat interface 36 with the end user 18 or other stakeholder such as a senior administrator, product tech support person, etc., until a resolution is obtained. A visual indicator 38 may be included within the admin app 34 to provide a status of the event (e.g., green dot indicates the issue is resolved, blue dot indicates the issue is waiting to be addressed, orange dot indicates the issue is being addressed, and red dot indicates the issue has not yet been addressed for greater than 30 minutes).

Regardless of how the resolution is obtained event, feedback module 32 communicates all the relevant information back to machine learning system 42, which processes and stores the event resolution information in KDB 40. The information generally includes a description of the issue, solution(s) applied, resolution success, etc., which can be used to further train the model, update confidence information, etc. In the case where chat interface 36 was utilized to resolve the issue, the NL chat inputs are likewise captured and processed by NL processor 44 and machine learning system 42, and stored by KDB 40.

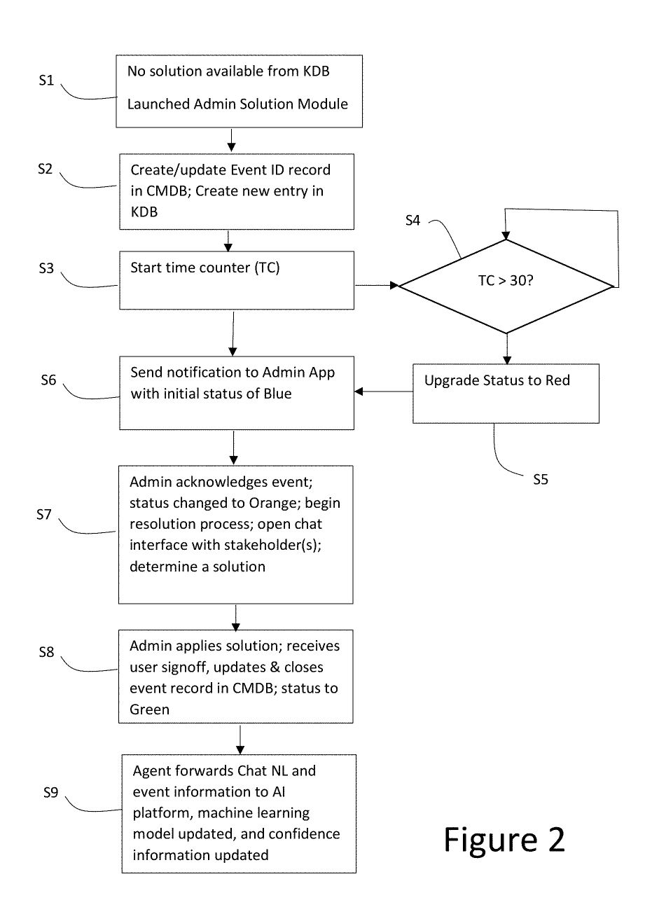

FIG. 2 depicts a flow diagram of an illustrative process of utilizing cognitive agent 12 (FIG. 1) when no matching event/solution is available from KDB 40 for a received event. In this case, administrative solution module 30 is launched at S1 and at S2 an event ID record is created (or updated) in CMDB 46. In addition, a new entry for the event is created in KDB 40. At S3, a time counter is started to keep track of the response time and at S4 a notification is forwarded to the admin app 34 of a selected administrator. A color status of, e.g., blue, may be displayed on four dot interface 38 to indicate that the event was opened but not yet acknowledged by the administrator. At the same time, the time counter is checked to see if a threshold time period (e.g., 30 minutes) has been exceed at S4. If yes, then the color state is upgraded to red and displayed on the admin app 34.

At S7, the administrator acknowledges the event via the admin app 34 and the color status is changed to orange (indicating that the event is open and acknowledged). The administrator then begins to resolve the problem, including opening chat interface 36 and engaging in an NL dialog with one or more stakeholders (e.g., end user 18, tech support personnel, other administrators, etc.). Once resolved, the administrator applies the solution at S8, receives a sign-off (e.g., from the end user 18 or other stakeholder) that the problem is fixed and updates and closes the event record in CMDB 46. At this time, the color status is changed to green by the cognitive agent 12. At S9, cognitive agent 12 forwards the chat NL and other event resolution information (e.g., solution, time/date, end user, etc.) to AI platform 14, which processes the NL, updates the machine learning model, stores the information in KDB 40 and updates the confidence information for the event.

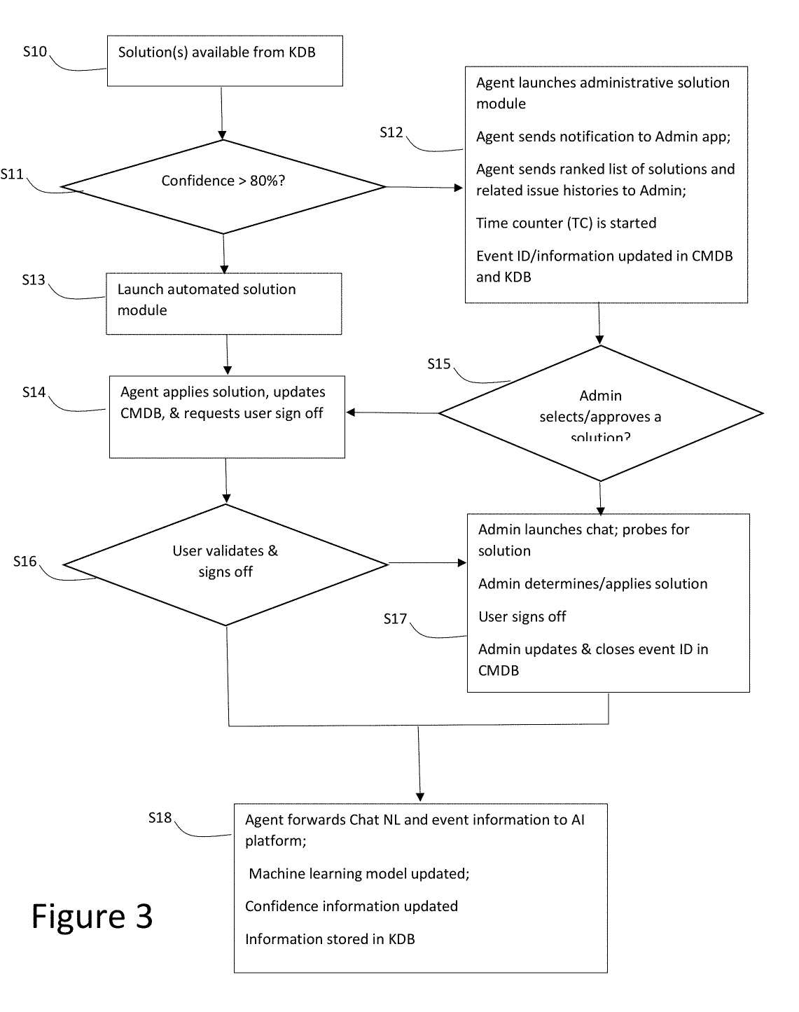

FIG. 3 depicts a flow diagram of an illustrative process of utilizing cognitive agent 12 (FIG. 1) when one or more solutions are returned from KDB 40 for a received event (S10). In this case, a determination is made at S11 whether a matching event/solution has a confidence greater than a predetermined threshold (e.g., 80%). If yes, then cognitive agent 12 launches automated solution module 28 at S13, and at S14 cognitive agent 12 applies the solution of the matching event, updates CMDB 46, and requests a user validation and sign-off (e.g., from an end user or stakeholder). At S16, a determination is made whether the user validates that the solution worked and the signed off.

If the confidence level back at S11 was less than the threshold (e.g., 80%), then cognitive agent 18 launches administrative solution module 30 at S12, which causes a notification to be sent to the admin app 34. The administrator then receives a ranked list matching events/solutions and resolution histories (e.g., as determined by the discovery service 43) and the time counter (TC) is started. The event information is updated in both CMDB 46 and KDB 40. Next, at S15, the administrator determines if one of the matching events/solutions in the list will likely result in a positive resolution and if so selects/approves the solution. If a solution is approved/selected at S15 by the administrator, the solution is applied at S14. If a solution is not approved/selected by the administrator at S15, or the user does not validate/sign off at S16, then the administrator launches chat interface 36 and probes for a solution at S17. Once a solution is determined, the administrator applies the solution and if successful obtains user sign off. The administrator then updates and closes the event in CMDB 46.

If the user validates/signs off at either S16 or S17, then the feedback module 32 in cognitive agent 18 forwards the chat NL and resolution information to AI platform 14 which updates the machine learning model, stores the information in KDB 40 and updates confidence information.

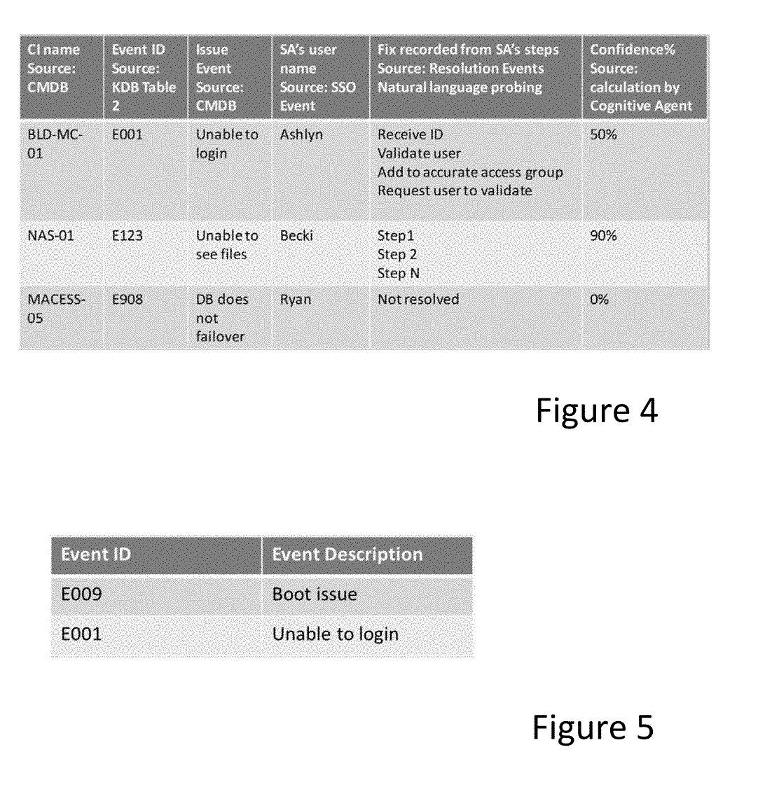

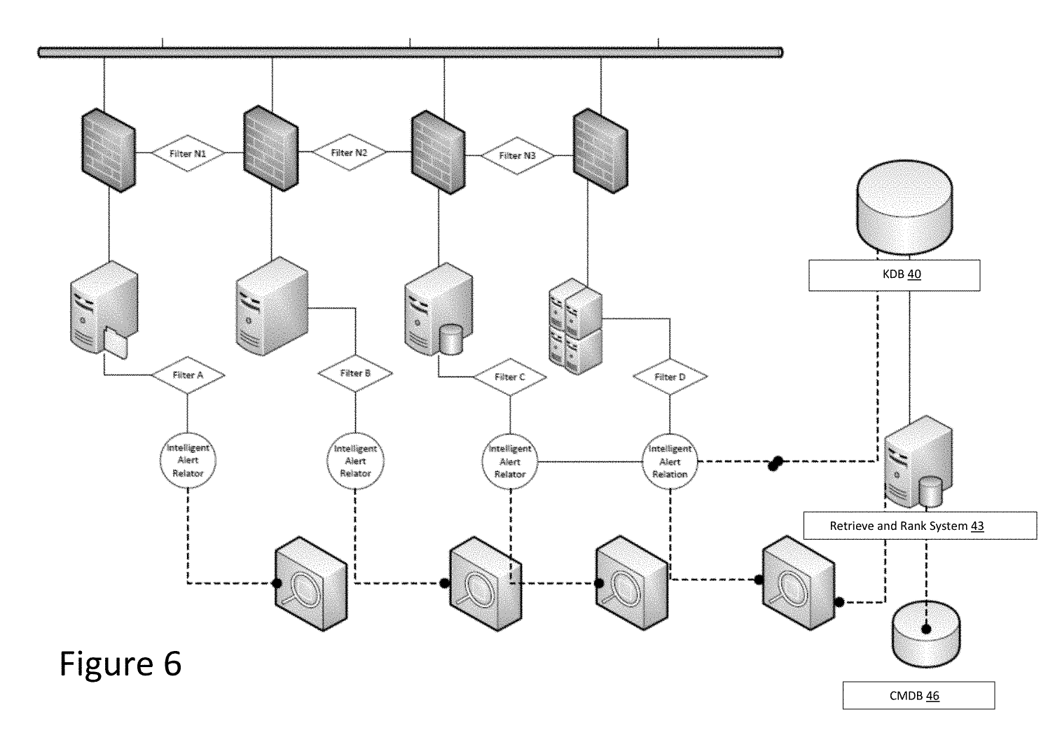

FIG. 4 depicts an illustrative event resolution log table within KDB 40. The columns sequentially list resolution elements including the impacted IT resource, event IDs, event description, system administer handling the event, solution information, and confidence score. FIG. 5 shows a log table in which events are sorted to show only the event ID and event description.

FIG. 6 depicts an illustrative process for implementing an event scanner. In this example, Filter A probes application based alerts from a common error pool. Intelligent Alert relators probe and check if an alert corresponds to a particular application (e.g., SQL). Filters B, C and D check the dependency of alerts from subsystems and the events already existing in KDB 40. Filters N1, N2, N3 check network based alert symptoms and relate them to server based alerts. Errors are related and searched based on the CMDB 46 and analyzed using discovery system 43.

It is understood that cognitive agent 12 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

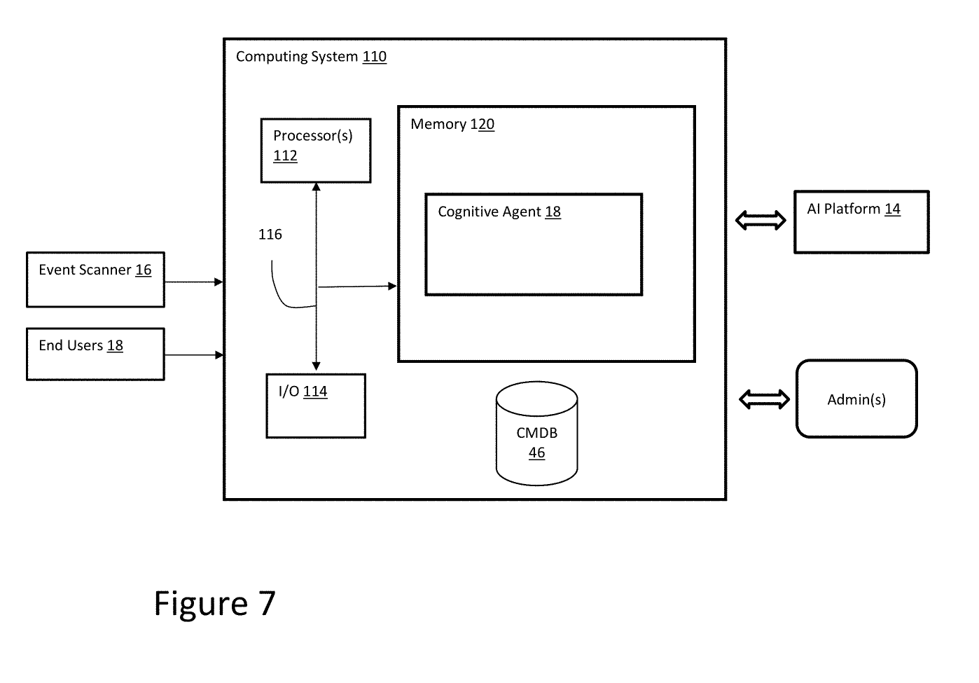

FIG. 7 depicts a computing system 110 that may comprise any type of computing device and for example includes at least one processor 112, memory 120, an input/output (I/O) 114 (e.g., one or more I/O interfaces and/or devices), and a communications pathway 116. In general, processor(s) 12 execute program code which is at least partially fixed in memory 120. While executing program code, processor(s) 112 can process data, which can result in reading and/or writing transformed data from/to memory and/or I/O 114 for further processing. The pathway 116 provides a communications link between each of the components in computing system 110. I/O 114 can comprise one or more human I/O devices, which enable a user to interact with computing system 110. Computing system 110 may also be implemented in a distributed manner such that different components reside in different physical locations.

Furthermore, it is understood that the cognitive agent 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of handling events gathered from an information technology (IT) infrastructure, comprising:
receiving an event in the form of a human readable message;
using a discovery service that includes a machine learning model to process the event relative to a knowledgebase of previously captured events;
identifying a set of matching events and associated solutions;
in response to identifying a matching event that has a solution confidence greater than a predetermined threshold, automatically applying the solution to obtain a resolution; and
updating the machine learning model based on the resolution.

2. The method of claim 1, wherein the event is obtained from an event scanner that probes the IT infrastructure.

3. The method of claim 1, wherein the event is obtained from natural language inputs of an end user.

4. The method of claim 1, further comprising notifying an administrator of the event when there are no matching events or there are no matching events having a solution confidence greater than the predetermined threshold.

5. The method of claim 4, further comprising capturing a natural language chat utilized between the administrator and a user in probing for a solution.

6. The method of claim 1, further comprising:
storing the event in the knowledge data base along with the solution in a human readable format; and
updating the solution confidence based on the resolution.

7. The method of claim 1, wherein the discovery system utilizes a learning to rank algorithm for ordering matching events.

8. A computing system having a cognitive agent for handling events gathered from an information technology (IT) infrastructure, comprising:
an event analyzer module for receiving an event;
a solution availability module that interfaces with a machine learning system to process the event relative to a knowledgebase of previously captured events and to identify a set of matching events and associated solutions;
an automated solution module that automatically applies the solution to obtain a resolution in response to identifying a matching event that has a solution confidence greater than a predetermined threshold;
an administrative solution module that notifies an administrator of the event when there are no matching events or there are no matching events having a solution confidence greater than the predetermined threshold; and
a feedback module for updating a machine learning model based on the resolution.

9. The computing system of claim 8, wherein the event is obtained from an event scanner that probes the IT infrastructure.

10. The computing system of claim 8, wherein the event is obtained from natural language inputs of an end user.

11. The computing system of claim 8, further comprising capturing a natural language chat utilized between the administrator and a user in probing for a solution.

12. The computing system of claim 11, wherein the natural language chat is stored in the knowledge base.

13. The computing system of claim 8, wherein the feedback module stores the event in the knowledge data base along with the solution in a human readable format, and updates the solution confidence based on the resolution.

14. The computing system of claim 8, wherein the machine learning system utilizes an intelligent sorting algorithm for ordering matching events.

15. A computer program product stored on a computer readable storage medium, which when executed by a computing system, provides handling events gathered from an information technology (IT) infrastructure, the program product comprising:
program code for receiving an event in the form of a human readable message;
program code for interfacing with a machine learning system to process the event relative to a knowledgebase of previously captured events;
program code for capturing a set of matching events and associated solutions from the machine learning system;
program code for automatically applying the solution to obtain a resolution in response to identifying a matching event that has a solution confidence greater than a predetermined threshold; and
program code for providing event resolution information to the machine learning system to update an associated machine learning model.

16. The program product of claim 15, wherein the event is obtained from an event scanner that probes the IT infrastructure.

17. The program product of claim 15, wherein the event is obtained from natural language inputs of an end user.

18. The program product of claim 15, further comprising notifying an administrator of the event when there are no matching events or there are no matching events having a solution confidence greater than the predetermined threshold.

19. The program product of claim 18, further comprising program code for capturing a natural language chat utilized between the administrator and a user in probing for a solution.

20. The program product of claim 15, further comprising program code for outputting event information in the knowledge database for updating the solution confidence based on the resolution.
